(19) United States
(12) Patent Application Publication
(10) Pub. No.: US 2005/0191455 A1
(43) Pub. Date: Sep. 1, 2005

(54) Modified self-adhesive notepapers

(76) Inventor: Kwei-Chen Hsu, Jhubei City (TW)

Correspondence Address: SUPREME PATENT SERVICES, POST OFFICE BOX 2339, SARATOGA, CA, 95070, US

(21) Appl. No.: 10/964,349

(22) Filed: Oct. 12, 2004

(30) Foreign Application Priority Data
Nov. 28, 2003 (TW) 092221045

(51) Int. Cl. A47K 10/24; B65H 1/00; B32B 33/00; B32B 9/00

(52) U.S. Cl. 428/40.1

(57) ABSTRACT

A modified notepaper is provided, including a paper, an adhesive area coated with a special glue, and at least a folding line cutting across the paper and bordering on the edge of the adhesive area. The adhesive area is usually on the back side of the paper, and forms a shape of stripe closer to an edge of the paper. The folding line is placed between the adhesive area and the rest of the available writing space of the back side. The folding line is bordering on the edge of the adhesive area so that the maximum area is available when the notepaper is folded along the folding line. The folding line can be a continuous dent trench formed by a press machine, a dash dent trench formed by a press machine, or a series of tooth holes, or perforation line, formed by a punch machine. A plurality of folding lines can also be implemented.

### BACKGROUND OF THE INVENTION

1. Field of the Invention

The present invention relates to a modified self-adhesive notepaper, and in particular to a self-adhesive notepaper with at least a folding line so that the notepaper can be folded and posted on both sides.

2. The Related Art

Self-adhesive notepapers come handy when one person tries to leave a note for another person, or uses it as a personal reminder. The self-adhesive notepaper is a small-sized paper with a special adhesive material coated on a small area of its back, usually in a shape of a stripe. The special adhesive material allows the notepaper to be easily removed without leaving any trace on the surface the note originally adhered to.

However, the observation shows that most people only use one side of the notepapers even though that both sides of the note have space to write message on. This is because that the bask side of the notepaper with the small area coated with adhesive material is usually facing away from the view when the note is posted. As a notepaper usually costs more than a regular paper without the self-adhesion, it is worth the effort to have the notepaper redesigned, so that a user can fully utilized the spaces available on both sides of the note.

### SUMMARY OF THE INVENTION

The primary objective of the present invention is to provide a self-adhesive notepaper that the space available on both sides of the note can be fully utilized. The present invention includes a folding line along the adhesive area, usually forming a narrow band. When the notepaper is used for the first time, the message can be written on the front side, and the note can be post as the regular notepaper. In addition, the notepaper can be folded along the folding line so that the rest of the area on the back side can face the viewer, while the adhesive area on the back adheres to a flat surface. In this way, both sides of the modified notepaper of the present invention can be fully utilized.

The advantages of the modified notepapers over the regular notepapers include:
1. Cost reduction: both sides of the modified notepaper can be utilized for the cost of one regular notepaper;
2. Environmental friendliness: the amount of paper waste can be reduced as more messages can be written on a modified notepaper; and
3. Easy production: the manufacturing process can be easily carried out with value-added feature of the modified notepaper.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 is a front view of the present invention;

FIG. 2 is a back view of the present invention;

FIG. 3 is a sectional diagram of the structure of the notepaper in accordance with the present invention;

FIG. 4 is a notepaper that is bent along the folding line;

FIG. 5 is a sectional diagram of a folded notepaper with its back side facing the viewer in accordance with the invention.

### DETAILED DESCRIPTION OF THE PREFERRED EMBODIMENT

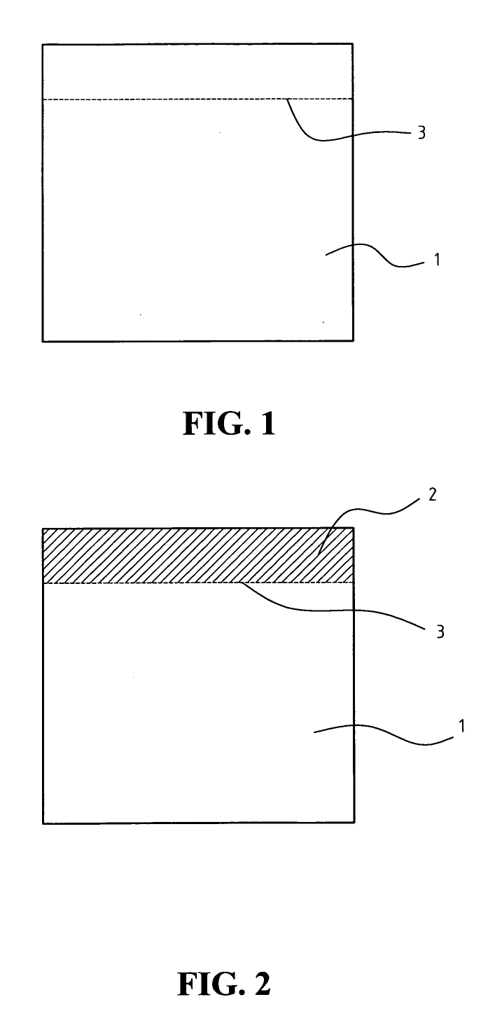

FIG. 1 and FIG. 2 show the front view and the back view of a modified notepaper of the present invention, respectively. As shown in FIG. 1 and FIG. 2, a modified notepaper comprises a paper 1, an adhesive area 2 coated with a special glue, and at least a folding line 3 cutting across paper 1 and bordering on the edge of adhesive area 2. Paper 1 is usually small in size, although large-sized notepapers can also be manufactured. In addition, paper 1 can be of any shape, although a rectangular shape is shown in the embodiment. Adhesive area 2 is usually on the back side of paper 1, and forms a shape of stripe closer to an edge of paper 1, as shown in the embodiment. However, the adhesive area can be of any shape. Folding line 3 is placed between adhesive area 2 and the rest of the available writing space of the back side. Folding line 3 is bordering on the edge of adhesive area so that the maximum area is available when the notepaper is folded along folding line 3. Folding line 3 can be a continuous dent trench formed by a press machine, a dash dent trench formed by a press machine, or a series of tooth holes, or perforation line, formed by a punch machine. A plurality of folding lines 3 can also be implemented.

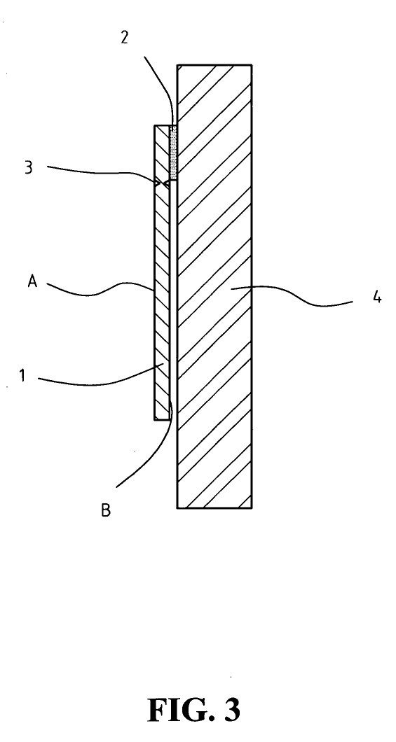

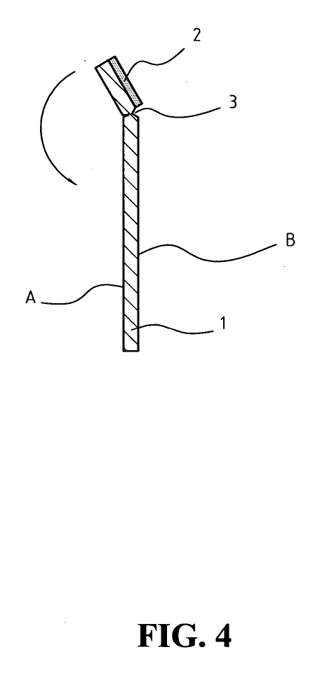

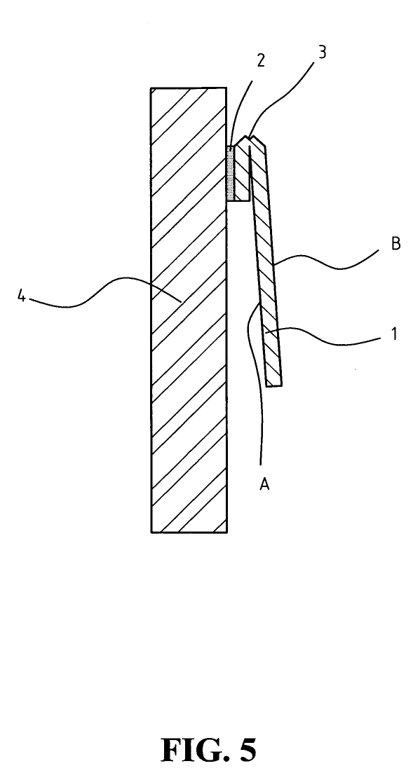

FIG. 3, FIG. 4 and FIG. 5 show how an embodiment of the notepaper of the present invention is in use. In FIG. 3, the notepaper of the present invention adheres, with adhesive area 2, to a surface of an object 4. As shown in FIG. 3, the front side A is facing the viewer, and the back side B is facing the away from the viewer and towards object 4. Front side A is used for message writing, as a conventional regular notepaper. When the user uses the notepaper for a second message or in reply to the first message, the user folds along folding line 3 and bends paper 1 towards the direction of front side A, as indicated in FIG. 4, so that adhesive area is still exposed. In FIG. 5, adhesive area 2 of the notepaper adheres to object 4, and back side B of paper 1 is now facing the viewer and available for message writing.

It is worth noticing that the folding of the notepaper does not impair the adhesiveness of adhesive area 2, as paper 1 is bended in the direction so that adhesive area 2 can still be used to adhere to a surface of any object.

With the notepaper of the present invention, both sides of the note can be used for message exchange. It does not only reduce the expense on post-it paper, but also reduce the paper waste imposed on the environment. In addition, the manufacture process of this value-added feature can be easily carried out.

Although the present invention has been described with reference to the preferred embodiments thereof, it is apparent to those skilled in the art that a variety of modifications and changes may be made without departing from the scope of the present invention which is intended to be defined by the appended claims.

1. A modified self-adhesive notepaper, comprising: a paper, an adhesive area on a back side of said paper, formed close to an edge of said paper, and at least a folding line cutting across said paper and bordering on an edge of said adhesive area, said folding line being placed between said adhesive area and the rest of the available writing space of said back side of said paper. Folding line 3 can be a continuous dent trench formed by a press machine, a dash dent trench formed by a press machine, or a series of tooth holes formed by a punch machine. A plurality of folding lines 3 can also be implemented.

2. The modified self-adhesive notepaper as claimed in claim 1, wherein the folding line extends along the lower edge of the backing tape so that a maximum area is available when said notepaper is folded along said folding line.

3. The modified self-adhesive notepaper as claimed in claim 1, wherein said folding line is a continuous dent line formed by a press machine.

4. The modified self-adhesive notepaper as claimed in claim 1, wherein said folding line is a perforation line formed by a punch machine.

5. The modified self-adhesive notepaper as claimed in 1, wherein said folding line is formed on a non-adhesive side of said notepaper, and being placed bordering said lower edge of said adhesive area on the opposite side of said paper.

6. The modified self-adhesive notepaper as claimed in 1, wherein said folding line is a dash dent line across the surface of said notepaper.
